(19) United States
(12) Patent Application Publication
(10) Pub. No.: US 2024/0078281 A1
(43) Pub. Date: Mar. 7, 2024

(54) METHODS AND DEVICES FOR FAST FOURIER TRANSFORMS

(71) Applicant: STMicroelectronics, Inc., Coppell, TX (US)

(72) Inventor: Andrea Lorenzo Vitali, San Jose, CA (US)

(21) Appl. No.: 18/505,770

(22) Filed: Nov. 9, 2023

Related U.S. Application Data
(63) Continuation of application No. 17/161,291, filed on Jan. 28, 2021.

(51) Int. Cl. G06F 17/14

(52) U.S. Cl. CPC G06F 17/142

(57) ABSTRACT

A method of operating a microcontroller to perform a Fast Fourier Transform, the method including receiving, by the microcontroller, N samples from a signal; and performing, by the microcontroller, a first butterfly operation of the Fast Fourier Transform before all of the N samples have been received from the signal, based on the performing of the first butterfly operation, the microcontroller performs the Fast Fourier Transform at a higher performance to power efficiency than a Fast Fourier Transform operation that begins after all of the N samples are received.

### CROSS-REFERENCE TO RELATED APPLICATIONS

This application is a continuation of U.S. application Ser. No. 17/161,291, filed on Jan. 28, 2021, which application is hereby incorporated herein by reference.

### TECHNICAL FIELD

This application relates to methods and devices to improve the resolution, speed, and power efficiency of devices that perform Fast Fourier Transforms.

### BACKGROUND

The Fast Fourier Transform (FFT) reduces the number of computations needed to perform a Discrete Fourier Transform. However, the power and latency of the FFT scale as the number of samples increases. Increasing the efficiency of the FFT may allow a device with an improved tradeoff between power, time, and resolution.

### SUMMARY

In accordance with an embodiment of the present invention, a method to improve the tradeoff between power, speed, and resolution of a microcontroller performing a Fast Fourier Transform includes receiving, by the microcontroller, N samples from a signal; and performing, by the microcontroller, a first butterfly operation of the Fast Fourier Transform before all of the N samples have been received from the signal, based on the performing of the first butterfly operation, the microcontroller performs the Fast Fourier Transform at an improved tradeoff between power, speed, and resolution.

In accordance with an embodiment of the present invention, a method to improve the tradeoff between power, speed, and resolution of a microcontroller performing a Fast Fourier Transform includes: receiving, by the microcontroller, N samples from a signal; performing, by the microcontroller, N/2*log₂(N) butterfly operations of the Fast Fourier Transform using the N samples; and initializing a performance of a first butterfly operation when a first data set becomes available, based on the performance of the first butterfly operation.

In accordance with an embodiment of the present invention, An electronic device to perform a Fast Fourier Transform, the electronic includes: an interface configured to receive N samples collected from a signal; a processor coupled to the interface; and a non-transitory memory storing a program to be executed in the processor, the program comprising instructions when executed, causes the processor to perform a first butterfly operation of the Fast Fourier Transform before all of the N samples have been collected from the signal.

### BRIEF DESCRIPTION OF THE DRAWINGS

One or more embodiments will now be described, by way of example only, with reference to the annexed figures, wherein:

FIG. 1 depicts the operations of an 8-point traditional FFT;

FIG. 2A depicts a bar chart showing the latency of a traditional FFT performed with minimal parallelism where operations are executed one by one, in sequence;

FIG. 2B depicts a bar chart showing the reduced latency of an FFT of an embodiment;

FIG. 3A depicts a bar chart showing the latency and computational intensity of a traditional FFT performed with maximum parallelism;

FIG. 3B depicts a bar chart showing the latency and reduced computational intensity or power of an FFT of an embodiment;

FIG. 4A through FIG. 4C depict the flow of data in a traditional FFT approach where all data is collected before computations;

FIG. 5A through 5C depict the flow of data in the FFT approach where data is processed immediately of an embodiment;

FIG. 6 depicts a device with an improved power, speed, and resolution tradeoff of an embodiment;

FIG. 7 depicts a device with an improved power, speed, and resolution tradeoff of an embodiment;

FIG. 8 depicts a flow chart illustrating a method of an embodiment to improve the tradeoff between power, speed, and resolution of a microcontroller performing a Fast Fourier Transform;

FIG. 9 depicts a flow chart illustrating a method of an embodiment to improve the tradeoff between power, speed, and resolution of a microcontroller performing a Fast Fourier Transform;

FIG. 10 depicts an early-fault detection system fan embodiment;

FIG. 11 illustrates an FFT accelerator of an embodiment.;

FIG. 12 illustrates a single-stage FFT accelerator of an embodiment; and

FIG. 13 depicts a single-unit FFT accelerator 1300 of an embodiment.

### DETAILED DESCRIPTION OF ILLUSTRATIVE EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised of at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments.

Fourier Transforms are useful for an innumerable variety of applications. Fourier Transforms may be used to decompose a signal into constituent parts. Commonly, Fourier Transforms may be used to transform the representation of a signal from a time domain to a frequency domain. Fourier Transforms, however, may also be used in a variety of other contexts, such as conversions into spatial frequencies, and may be used for image processing, fault detection, and many other applications. Inverse Fourier Transforms may also reverse the process, for example, from the frequency domain to the time domain.

For digital processing, a Discrete Fourier Transforms (DFT) may be performed on a set of samples taken from a continuous signal. For a DFT, N output frequencies are computed from N samples by summing all N input samples, each multiplied by a complex factor. However, the number of computations used for DFT processing can quickly burden the resources of a processing system, or microcontroller, as the number of computations needed increases exponentially as the number of samples increases. For an N-point DFT, a total of N² complex multiplications are required. For 1,024 samples, 1,048,576 complex multiplications are needed.

The Fast Fourier Transform reduces the number of computations needed to perform a Fourier Transform by taking a divide-and-conquer approach. An N-point FFT is recursively split into smaller divisions until it is reduced into N/2, two-point FFTs. During a first stage, N/2 butterfly operations may be performed (one for each of the two-point FFTs). During a second stage, N/2 additional butterfly operations may be performed on the outputs of butterfly operations of the first stage. During a third stage, N/2 additional butterfly operations may be performed on the outputs of the second stage. And, this process may be continued for as many additional stages as needed. The number of stages is equal to Log₂(N) and produce N outputs after the final stage. The total number of butterfly operations (each of which may require a complex multiplication) is equal to (N/2)*(Log₂(N)). This represents a significant reduction from the N² calculations required for the traditional N-Point DFT. For a 1,024 point transform, the number of complex multiplications is reduced from 1,048,576 to 5,120 complex multiplications.

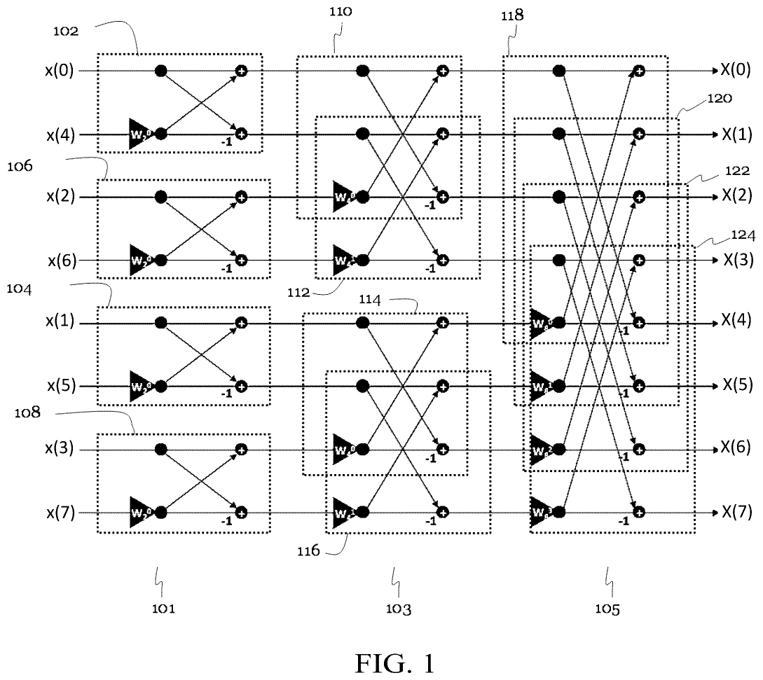

FIG. 1 Depicts the operations of an 8-point FFT.

The input samples for the FFT are represented by x(0), x(1), . . . x(N) and the outputs are represented by X(0), X(2) . . . X(N). For an 8 point FFT, the number of stages (Log₂(8)) equals 3. During a first stage 101, a first butterfly operation 102 may receive a first sample x(0) and a fifth sample x(4) as inputs. A second butterfly operation 104 may receive a second sample x(1) and a sixth sample x(5) as inputs. A third butterfly operation 106 may receive a third sample x(2) and a seventh sample x(6) as inputs. A fourth butterfly operation 108 may receive a fourth sample x(3) and an eighth sample x(7) as inputs.

Each butterfly operation may comprise complex operations like complex multiplication, complex addition, and complex subtraction. Complex Multiplications are denoted by the triangles in FIG. 1, complex additions are denoted by “+,” and complex subtractions are denoted by a “+” and a “−1.”

The complex operation input data received for the butterfly operations are multiplied by a coefficient W. W is determined as a function of factors N and n. Note that N is not to be confused with N referring to the number of samples of a FFT. In FIG. 1, N is represented by the subscript of W, and n is represented as the superscript for W. In the context of coefficient calculation N=2ⁱ, where i is the stage of the of the FFT (numbered from 1). And, n ranges from 0 to 2⁽ⁱ⁻¹⁾−1. Thus, W may be described by Equation 1 below.

$$W = {e}^{i 2 π \frac{n}{N}} \qquad Equation 1$$

The results of the first butterfly operation 102, the second butterfly operation 104, the third butterfly operation 106, and the fourth butterfly operation 108 may be used during a second stage 103 of the FFT. During the second stage 103 of the FFT, N/2 additional butterfly operations may be performed. A fifth butterfly operation no may be performed using an output of the first butterfly operation 102 and the third butterfly operation 106. A sixth butterfly operation 112 may be performed using the other output of the first butterfly operation 102 and the other output of the third butterfly operation 106. A seventh butterfly operation 114 may be performed using an output of the second butterfly operation 104 and the fourth butterfly operation 108. An eighth butterfly operation 116 may be performed using the other output of the second butterfly operation 104 and the other output of the fourth butterfly operation 108. It should be noted that the depiction of the area of the butterfly operations in the second stage and the third stage may appear to overlap. But, each butterfly operation includes two inputs and two outputs. For example, graphically, the fifth butterfly operation no is performed on the line beginning with the x(0) input and the line beginning with the x(2) input.

The results of the fifth butterfly operation no, the sixth butterfly operation 112, the seventh butterfly operation 114, and the eighth butterfly operation 116 are used during a third stage 105 of the FFT. During the third stage 105 of the FFT, N/2 additional butterfly operations are performed. A ninth butterfly operation 118 is performed using an output of the fifth butterfly operation no and the seventh butterfly operation 114. A tenth butterfly operation 120 is performed using an output of the sixth butterfly operation 112 and the eighth butterfly operation 116. An eleventh butterfly operation 122 is performed using an output of the fifth butterfly operation no and the seventh butterfly operation 114. A twelfth butterfly operation 124 is performed using an output of the sixth butterfly operation 112 and the eighth butterfly operation 116. The total number of butterfly operations needed for the FFT depicted in FIG. 1 is 12 ((8/2)*(Log₂(8)).

The time needed to perform an FFT corresponds to the number of operations needed for the performance of the FFT. The greater the number of samples, the more operations, the more time needed to perform an FFT, and the more power and processing resources utilized. Reducing the time needed to perform an FFT may improve the performance of a device, or microcontroller, that performs the FFT. This may also improve a tradeoff between power efficiency and performance (speed) of a microcontroller, or device that performs an FFT.

Traditional approaches to performing the FFT collect the N samples needed for the FFT before butterfly operations are performed. No operations are performed while samples are being collected. This can result in latency periods that scale with the number of computations of the FFT, (N/2)*(Log₂(N)). The latency of an FFT may be defined as the length of time beginning when a final sample for the FFT is collected and ending when the FFT is complete. As can be appreciated, the latency may become undesirable for applications utilizing a large number of samples. However, reducing the number of samples may reduce the frequency resolution of the FFT, which may degrade quality. And, in various applications, speed may be critical for success so it may be advantageous to reduce the latency of FFTs.

Returning to FIG. 1 as an example, using traditional approaches, all eight samples x(0), x(1), . . . x(8) are collected before the first butterfly operation 102 is performed. If all the butterfly operations are performed sequentially, twelve operations of the 8-point FFT must be performed after the eight samples are collected. The more samples taken, the longer the latency.

Parallel processing may reduce the latency of traditional FFTs. However, improvements from parallel processing are capped because each stage of an FFT uses data from previous stages. And, while parallel processing may reduce latency periods, parallel processing may burden the processing resources of a system, or microcontroller, by compacting a large number of computations in a small window of time. This may adversely impact the power efficiency of a microcontroller, or other device, that performs the FFT. Further, parallel processing may require additional hardware resources that may be inefficient for certain applications that may benefit from reduced latency.

Returning again to FIG. 1, for further explanation, using a classical approach to perform an FFT with a parallel processing approach, all eight samples x(0), x(1), . . . x(8) are collected before any butterfly operations are performed. However, only the four butterfly operations of the first stage 101 may be performed during a first time period because the four butterfly operations of the second stage 103 use output from the butterfly operations of the first stage 101 as input. Likewise, the four butterfly operations of the third stage 105 cannot be completed until the butterfly operations of the second stage 103 are completed. Further, for parallel processing using a traditional approach, the resources needed for the processing increase with the number of samples per stage, so it may be advantageous to utilize less costly approaches.

Parallel processing may also lead to sustained peak processing. As will be appreciated, N/2 butterfly operations may be needed per stage. With parallel processing, N/2 butterfly operations may need to be performed for Log₂(N) number of stages. Sustaining the processing peak for an extended period of time may introduce inefficiencies in power consumption, and prolonged peaks may not be sustainable by the power source. Due to power-efficiency costs associated with parallel processing, and the reduction in resolution caused by reducing the number of samples (and time) for a given FFT, a device performing an FFT faces a tradeoff between speed, resolution, and power.

Tradeoffs in power efficiency and latency may be improved for devices, like microcontrollers, that perform FFTs. In various embodiments, a method to perform an FFT of various embodiments of this disclosure may comprise initializing butterfly operations before receiving all the samples needed to perform the Fast Fourier Transform. This provides a head start for the FFT, which may improve performance and limit the duration of processing peaks without sacrificing resolution.

Returning again to FIG. 1, the first butterfly operation 102 receives input from the first sample x(0) and the fifth sample x(4). Using embodiments of the method of this disclosure, instead of waiting for all the samples, the first butterfly operation 102 may be performed as soon as the first sample x(0) and the fifth sample x(4) are ready. This may occur before all samples have been received, providing a head start for the FFT. In various embodiments, the first butterfly operation 102 may be performed after N/2+1 samples are ready (or before the N/2+2 samples are ready).

As more samples become ready, more butterfly operations may be performed. Returning again to FIG. 1, The second butterfly operation 104, may be performed with the second sample x(1) and the sixth sample x(5). Thus, the second butterfly operation 104 may be performed as soon as the sixth sample x(5) is ready. The third butterfly operation 106 may be performed with the third sample x(2) and the seventh sample x(6). And, it may be performed as soon as the seventh sample x(6) is ready. Once the third butterfly operation is performed (the first butterfly operation having already been performed), the fifth butterfly operation 110 and the sixth butterfly operation 112 become ripe for performance because they use the outputs from the first butterfly operation 102 and the third butterfly operation. All the remaining butterfly operations (the fourth butterfly operation 108, the seventh butterfly operation 114, the eighth butterfly operation 116, the ninth butterfly operation 118, the tenth butterfly operation 120, the eleventh butterfly operation 122, and the twelfth butterfly operation 124) may be performed after the eighth sample x(7) is received.

Initializing the butterfly operations as soon as the data needed to perform them becomes available may reduce the latency of an FFT. In FIG. 1, there are 8 samples. Processing when data is available may allow five of the 12 butterfly operations to be performed before the eighth, and final, sample is collected. Instead of having 12 unperformed operations, only 7 operations remain. By beginning butterfly operations as soon as data is available, the number of unperformed butterfly operations after collecting the final sample may be reduced to N−1 butterfly operations. This represents a significant reduction from the (N/2)(Log_{2 (}N) operations that would remain using traditional approaches.

As the number of samples of an FFT is increased, the benefits of embodiments of this disclosure may also increase. Table 1, depicted below, shows how the number of remaining operations may be reduced as the number of samples increases by initializing butterfly operations before all the samples are collected.

TABLE 1

| | | Remaining | Advantageous |
|---|---|---|---|
| | Remaining Operations | Operations After | Reduction in |
| | After Final Sample: | Final Sample: | Remaining |
| Samples | Traditional FFT | FFT of Embodiment | Operations After |
| (N) | ((N/2)*Log2(N)) | (N − 1) | Final Sample |
| 8 | 12 | 7 | 5 |
| 128 | 448 | 127 | 321 |
| 256 | 1,024 | 255 | 769 |
| 512 | 2,304 | 511 | 1,793 |
| 1,024 | 5,120 | 1,023 | 4,097 |

As demonstrated by Table 1, embodiments of this disclosure realize significant reductions in the number of operations needed to be performed, and, thus the latency of the FFT. The performance of a microcontroller or other device may be improved without sacrificing resolution. For an 8 sample FFT, there may be a 42% reduction in latency due to a commensurate decrease in the number of unperformed operations remaining after the collection of the eighth sample. For a 128 sample FFT, there may be a 72% reduction in post-collection operations and latency. For a 512-sample FFT, there may be a 78% reduction in post-collection operations and latency. For a 1,024 sample FFT, that benefit grows to an 80% reduction in latency and post-collection operations.

Table 2 further illustrates how the number of post-collection operations is reduced by using embodiments of the FFT approach of the present disclosure over a traditional approach with minimal parallelism.

TABLE 2

| Time Period | Operations (Traditional) | Operations (of an Embodiment) |
|---|---|---|
| 1 | No op. | No op. |
| 2 | No op. | No op. |
| 3 | No op. | No op. |
| 4 | No op. | 1 butterfly op. (first stage) |
| 5 | No op. | 1 butterfly op. (first stage) |
| 6 | No op. | 1 butterfly op. (first stage) |
| 6 + t | No op. | 1/2 butterfly op. (second stage) |
| 6 + 2t | No op. | 2/2 butterfly op. (second stage) |
| 7 | 1/4 butterfly op. (first stage) | 1/1 butterfly op. (first stage) |
| 7 + t | 2/4 butterfly op. (first stage) | 1/2 butterfly op. (second stage) |
| 7 + 2 t | 3/4 butterfly op. (first stage) | 2/2 butterfly op. (second stage) |
| 7 + 3 t | 4/4 butterfly op. (first stage) | 1/4 butterfly op. (third stage) |
| 7 + 4 t | 1/4 butterfly op. (second stage) | 2/4 butterfly op. (third stage) |
| 7 + 5t | 2/4 butterfly op. (second stage) | 3/4 butterfly op. (third stage) |
| 7 + 6t | 3/4 butterfly op. (second stage) | 4/4 butterfly op. (third stage) |
| 7 + 7t | 4/4 butterfly op. (second stage) | *** |
| 7 + 8t | 1/4 butterfly op. (third stage) | *** |
| 7 + 9t | 2/4 butterfly op. (third stage) | *** |
| 7 + 10t | 3/4 butterfly op. (third stage) | *** |
| 7 + 11t | 4/4 butterfly op. (third stage) | *** |

As seen in Table 2, above, the latency after completion of the samples may be reduced. Where “t” represents the time to perform an operation, it takes 12 cycles for the traditional FFT to be completed. The FFT of an embodiment can complete the FFT in only 7 cycles after the seventh sample is ready. This is five fewer cycles than traditional approaches with minimal parallelism. And, represents a reduction of almost 42%, as discussed with reference to Table. 1. And, again, even greater reductions may be realized for FFTs performed with more samples.

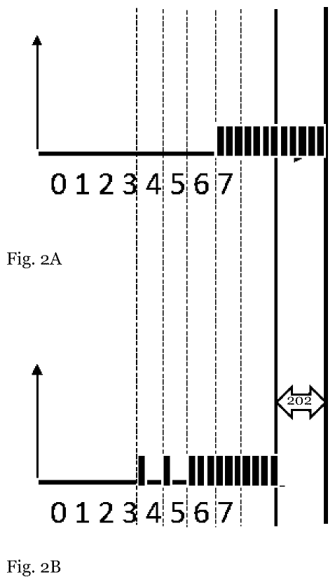

FIG. 2A depicts a bar chart showing the latency of a traditional FFT performed with minimal parallelism, where operations are executed one by one, in sequence.

FIG. 2B depicts a bar chart showing the reduced latency of an FFT of an embodiment.

The horizontal axis in FIG. 2A and FIG. 2B represents time (divided into sample periods) and the bars denote butterfly operations of an 8 sample FFT. In FIG. 2A, no butterfly operations are performed until 8^{th} time period. In contrast, in FIG. 2B, butterfly operations are begun in the fifth time period—consistent with an approach of embodiments of the present disclosure—as soon as the data needed to perform butterfly operations becomes available. This gives the FFT a head start on traditional FFTs. As a result, FFT of any embodiment may be able to finish earlier and realize a reduction in latency 202.

In various embodiments, devices utilizing an FFT of this disclosure may offer advantages over the traditional FFTs with parallel processing. By dispersing the (N/2)Log₂(N) calculations needed for an FFT over a longer period of time traditional parallel processing power efficiency may be improved. As will be appreciated, power consumption increases with computations and spreading out the computations over a longer time may reduce the overall power consumption and reduce stress on the power source.

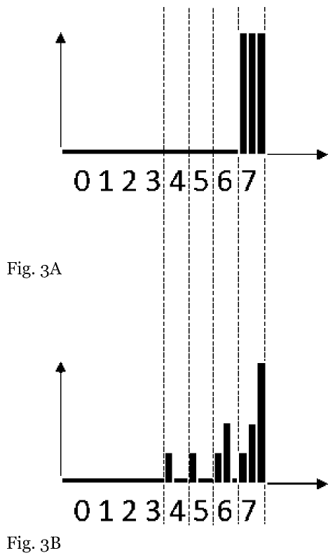

FIG. 3A depicts a bar chart showing the latency and computational intensity of a

traditional FFT performed with maximum parallelism.

FIG. 3B depicts a bar chart showing the latency and reduced computational intensity or power of an FFT of an embodiment.

In FIG. 3A and FIG. 3B, the horizontal axis again represents time divided into sample periods. For the examples of FIG. 3A and FIG. 3B, the number of samples, N, is 8. The vertical axis represents the number of operations performed. For traditional FFTs, the benefits of parallelism are limited because later-stage butterfly operations rely on the calculations performed in the earlier stages. As a result, traditional FFT with maximum parallelism will require a cycle for each stage of the FFT. Maximum parallelism refers to a scenario where all operations that can be executed in parallel are indeed executed simultaneously. This is represented in FIG. 3A by the three bars of equal height shown after the seventh sample is prepared. For a sample size of 8, the peak processing of four operations is sustained for three time periods. However, as the sample size increases, the number of periods needed to sustain peak operation increases. For example, a sample size of 1,024 requires 10 periods of sustained peak processing.

Using an approach of the present disclosure, the first butterfly operation may be performed after the fifth sample is ready (for an 8 sample FFT). Another may be performed after the sixth sample is ready, and three performed after the seventh sample is ready. Once the seventh sample is ready, only 7 butterfly operations (N−1) remain to complete the FFT. One of the butterfly operations is in the first stage, two are in the second stage, and three are in the fourth stage. The peak number of operations performed during any cycle may thus be four. And, in contrast, this peak level is only maintained for one cycle instead of three cycles, thereby cutting the length of time of the peak to ⅓ the time in FIG. 3A. This benefit only grows with the number of cycles. In various embodiments, a 1,024-sample FFT of an embodiment of this disclosure may have only one cycle at a peak level in contrast to the 10 cycles required for a 1,024-sample using a traditional FFT with parallelism.

As will be appreciated, reducing the length of the peak processing may also increase the efficiency of a microcontroller that performs an FFT. Some batteries may struggle to power a prolonged peak. It may also be beneficial to improve the performance of a microcontroller used for critical applications where speed impacts performance. Using various embodiments of the FFT of this disclosure allows latency to be reduced without reducing the number of samples (frequency resolution), or increasing the clock speed (which can detrimentally impact power efficiency). Further, advantages may be realized from embodiments of an FFT of this disclosure by allowing the clock period to be reduced while maintaining a latency period, which may allow operation at a desired resolution more economically. As will be appreciated, various embodiments of an FFT of this disclosure may be utilized in a wide variety of applications.

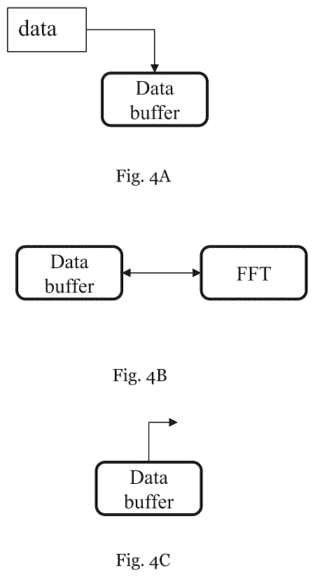

FIG. 4A through FIG. 4C depicts the flow of data in a traditional FFT approach where all data is collected before computations.

Traditional approaches to FFTs collect all the data needed before operations are performed on the samples. As shown in FIG. 4A, sample data is stored in a data buffer while all samples are collected.

Only after all the samples are collected, and the data buffer is filled, FFT operations are performed on the data. This is depicted in FIG. 4B, where data is retrieved, operated on, and returned to the data buffer. Where it can be retrieved for further operation.

Finally, as depicted in FIG. 4C, when the FFT is complete, the data buffer outputs the result (FFT coefficients).

In various embodiments of the present disclosure, a data buffer may be bypassed. And, samples may be processed as soon as available.

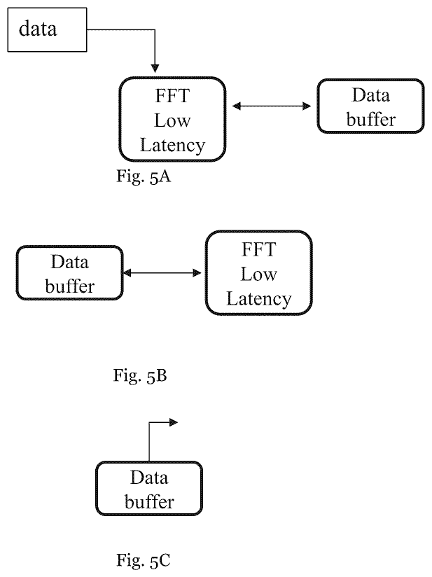

FIG. 5A through 5C depicts the flow of data in an FFT approach where data is processed immediately of an embodiment.

As depicted in FIG. 5A, data may be processed as soon as received. This may occur before it is directed to a data buffer. The data buffer may comprise a number of locations that is equal to the number of samples. For example, the data buffer may comprise 1,024 locations for a 1,024 sample FFT. Once the data is received, it may be determined whether any operations may be performed with the data. Operations may be performed accordingly, and then data stored in the data buffer.

For example, when a first sample of an 8-sample FFT of an embodiment of the present disclosure is received, no operations may be ripe for performance so the sample data may be stored in the data buffer. When the fifth sample is received, the FFT may retrieve the first sample from the data buffer and perform the first butterfly operation. The results from the butterfly operations may be stored in the data buffer until needed during a second stage.

Likewise, when a second sample is received, no operations may be ripe for performance so that it may be stored in the data buffer. When the sixth sample is received, the second sample may be retrieved, and the second butterfly operation may be performed. The results of the second butterfly operation may be stored in the data buffer. This may be repeated as more samples are received and more operations become ripe for performance. The remaining N-1 operations after the final sample is received may be performed after the final sample is received, and the final N results may be stored in N locations of the data buffer. The data buffer may then output the results.

In various embodiments of an FFT of the present disclosure, it may be desirable to have a sampling time that it is larger than, or equal to, the time needed to perform a butterfly operation. This may be desirable so that butterfly operations may be completed before new samples become available. This may be preferred when a dual buffer solution is not desired (where one buffer collects data while another is used for computing an FFT).

In various embodiments, it may be advantageous to have an intermediate data buffer to temporarily store samples if the sampling time is smaller than the time for processing a butterfly operation. The intermediate data buffer may comprise a First in First Out data buffer. Data from the intermediate data buffer may be retrieved when it is free to be processed. For example, a sample may be collected in stored in an intermediate, First in First Out Data Buffer temporarily while a butterfly operation is being performed. When the butterfly operation is complete, the sample may be delivered for processing. The size of an intermediate FIFO data buffer may vary depending on the sampling time and processing time for relevant operations. In various embodiments, the same data buffer may be used to temporarily store data and store the results of the FFT.

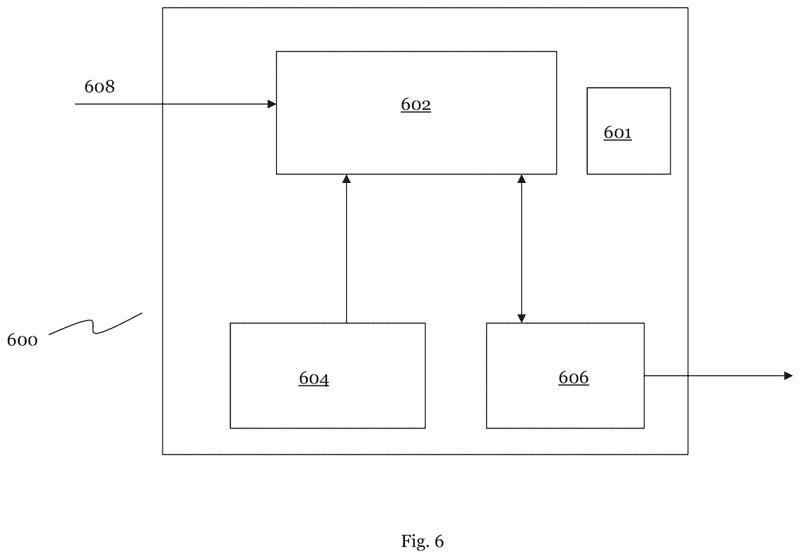

FIG. 6 depicts a device with an improved power, speed, and resolution tradeoff of an embodiment.

The device 600 to perform an FFT may comprise a processor 602. The processor 602 may be in communication with a memory 604. The processor 602 may also be in communication with a data buffer 606. In various embodiments, the device 600 may be a microcontroller. The device may comprise a battery 601. The battery 601 may power the operation of the device 600. In various embodiments, the device 600 may be powered by a power source not part of the device 600.

The processor 602 may receive sample data from an interface 608. The sample data may be collected from a signal to perform an FFT. Samples may be input to the processor 602 as they are collected.

The memory 604 may store an instruction set, that, when executed, causes the processor 602 to perform butterfly operations on samples as soon as the butterfly operations may be performed. If there are no butterfly operations ready to be performed when a sample is received, the instruction set may cause the processor 602 to store the sample in the data buffer 606. When a butterfly operation that needs the sample is ready to be performed, the processor 602 may retrieve the sample to perform the butterfly operation. The program, when executed, may cause the processor 602 to store the results of the butterfly operation in the data buffer 606. The processor 602 may retrieve intermediate results from the data buffer 606 for further butterfly operations. After all the butterfly operations are performed, the data buffer 606 may output the results. In various embodiments, the memory 604 may comprise a non-transitory computer-readable medium. In various embodiments, the data buffer 606 may comprise one data location for each of the N samples of an FFT.

In various embodiments, the instruction set, causes the processor 602 to perform a first butterfly operation of a Fast Fourier Transform before all of the N samples have been collected from the signal. In various embodiments, the instruction set, when executed, causes the first butterfly operation to be begun before N/2+2 samples of the N samples have been collected. In various embodiments, the instruction set, when executed, causes the processor 602 to perform a second butterfly operation before N/2+3 samples of the N samples have been collected. In various embodiments, memory 604 comprises a non-transitory computer-readable memory.

In various embodiments, the processor 602 may comprise a multi-core processor. A multi-core processor may allow butterfly operations to be performed in parallel. This may be beneficial to reduce latency. For example, returning to FIG. 1, using an FFT of an embodiment, after the eighth sample is collected, one butterfly operation remains unperformed in the first stage 101, two butterfly operations remain unperformed in the second stage 103, and three butterfly operations remain unperformed in the third stage 105. It may reduce latency to simultaneously perform the remaining two butterfly operations of the second stage 103. It may also reduce latency to simultaneously perform the four butterfly operations of the third stage 105. The number of cores of a multi-core processor may vary in various embodiments. For example, some embodiments may have two cores to perform two operations simultaneously. Other embodiments may have four cores to perform four operations simultaneously. As will be appreciated, various embodiments may comprise other numbers of cores.

It may be advantageous to start to perform butterfly operations before all samples are received or collected to improve the power efficiency of the battery 601. By reducing the duration of peak processing, power efficiency may be improved. And, in various embodiments, the performance of the device 600, or a microcontroller, may be improved by starting to perform butterfly operation before all samples are collected. This may allow the device 600, or microcontroller, to perform operations more quickly.

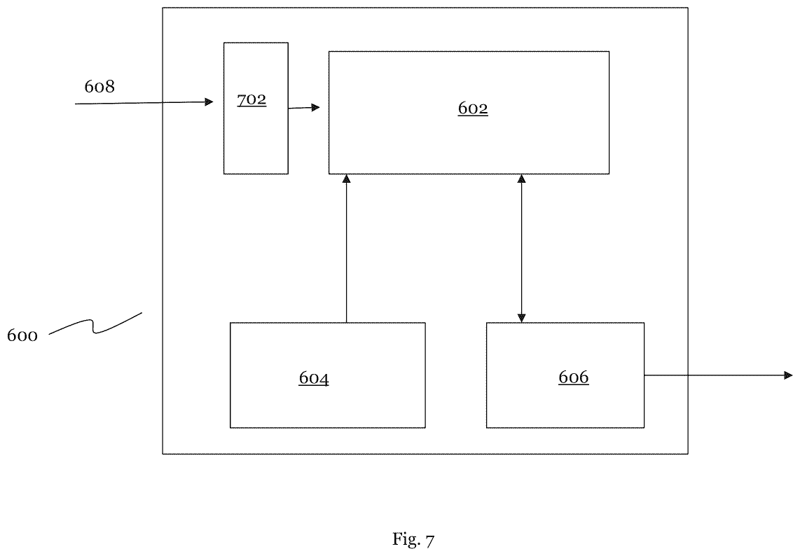

FIG. 7 depicts a device with an improved power, speed, and resolution tradeoff of an embodiment.

In various embodiments, the device 600 to perform an FFT may comprise an intermediate data buffer 702. The intermediate data buffer 702 may store data samples until processor 602 can process the data sample. It may be beneficial to have an intermediate data buffer 702 if data samples are collected more quickly than they may be processed for an FFT. The size (capacity) of the intermediate data buffer 702 may vary in various embodiments. In various embodiments, the data buffer 606 may comprise the intermediate data buffer 702.

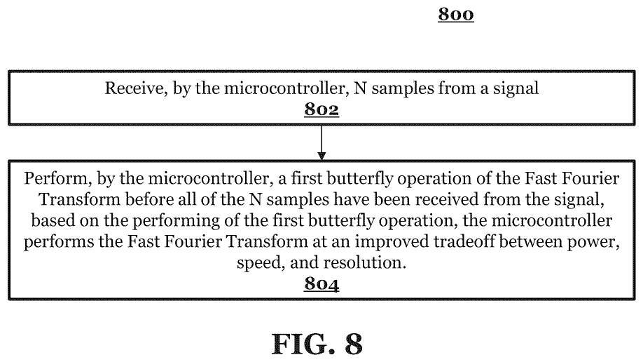

FIG. 8 depicts a flow chart illustrating a method 800 of an embodiment to improve the tradeoff between power, speed, and resolution of a microcontroller performing a Fast Fourier Transform.

In various embodiments, method 800 may comprise: at step 802 receiving, by the microcontroller, N samples from a signal; and at step 804 performing, by the microcontroller, a first butterfly operation of the Fast Fourier Transform before all of the N samples have been received from the signal, based on the performing of the first butterfly operation, the microcontroller performs the Fast Fourier Transform at an improved tradeoff between power, speed, and resolution.

In various embodiments, method 800 may further comprise, wherein the first butterfly operation is started before receiving N/2+2 samples of the N samples.

In various embodiments, the method 800 may further comprise, wherein the first butterfly operation is performed using a first chronological sample (the first sample received) of the N samples and an N/2+1 sample chronological sample of the N samples.

In various embodiments, the method 800 may further comprise, performing, by the microcontroller, a second butterfly operation before receiving N/2+3 samples of the N samples.

In various embodiments, method 800 may further comprise, wherein the second butterfly operation is performed using a second chronological sample of the N samples and an N/2+2 chronological sample of the N samples.

In various embodiments, the method 800 may further comprise, performing, by the microcontroller, N/2*log₂(N) butterfly operations.

In various embodiments, method 800 may further comprise, further comprising performing, by the microcontroller, N−1 butterfly operations after receiving all N samples from the signal.

In various embodiments, method 800 may further comprise, wherein each butterfly operation receives two input values and produces two output values.

In various embodiments, method 800 may further comprise, performing each butterfly operation of the Fast Fourier Transform using a multi-core processor of the microcontroller; and finishing the Fast Fourier Transform after N−1 butterfly operations are performed after all N samples are received by the microcontroller.

In various embodiments, method 800 may further comprise, performing each butterfly operation of the Fast Fourier Transform using a single-core processor of the microcontroller; and improving the performance of the single-core processor by reducing the number of butterfly operations performed after receiving the N samples.

In various embodiments, method 800, may further comprise, performing each butterfly operation of the Fast Fourier Transform using an FFT accelerator of the microcontroller.

In various embodiments, the method 800, may further comprise, triggering the performance of the first butterfly operation when a data-valid bit of a first input of the first butterfly operation is asserted and when a data-valid bit of a second input of the first butterfly operation is asserted.

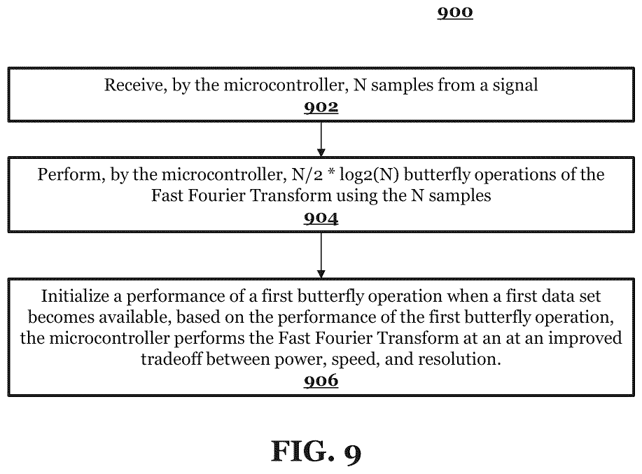

FIG. 9 depicts a flow chart illustrating a method of an embodiment to improve the tradeoff between power, speed, and resolution of a microcontroller performing a Fast Fourier Transform Detailed Description of Illustrative Embodiments.

In various embodiments, method 900 may comprise at step 902, receiving, by the microcontroller, N samples from a signal; at step 904, performing, by the microcontroller, N/2*log₂(N) butterfly operations of the Fast Fourier Transform using the N samples; and at step 906, initializing a performance of a first butterfly operation when a first data set becomes available, based on the performance of the first butterfly operation, the microcontroller performs the Fast Fourier Transform at a higher performance to power efficiency than a Fast Fourier Transform operation that begins after data sets for all of the butterfly operations become available.

In various embodiments, method 900 may further comprise, wherein the first data set comprises a first chronological sample of the N samples and an N/2+1 chronological sample of the N samples.

In various embodiments, method 900 may further comprise, initializing a second butterfly operation when a second data set becomes available.

In various embodiments, method 900 may further comprise, wherein the second data set comprises a second chronological sample of the N samples and an N/2+2 chronological sample of the N samples.

In various embodiments, method 900 may further comprise, initializing each of the N/2*log₂(N) butterfly operations when a corresponding data set becomes available.

Reducing the latency of an FFT may allow for early detection of anomalous vibrations of an electric motor. This may, in turn, allow early detection of a potential fault in the electronic motor and earlier corrective action.

For an electric motor, if any mechanical part is damaged, it will cause vibrations at a frequency that is a multiple of the rotation speed. The multiple may vary for different motors. The multiple may depend on the gears connected to the rotating shaft of the electric motor.

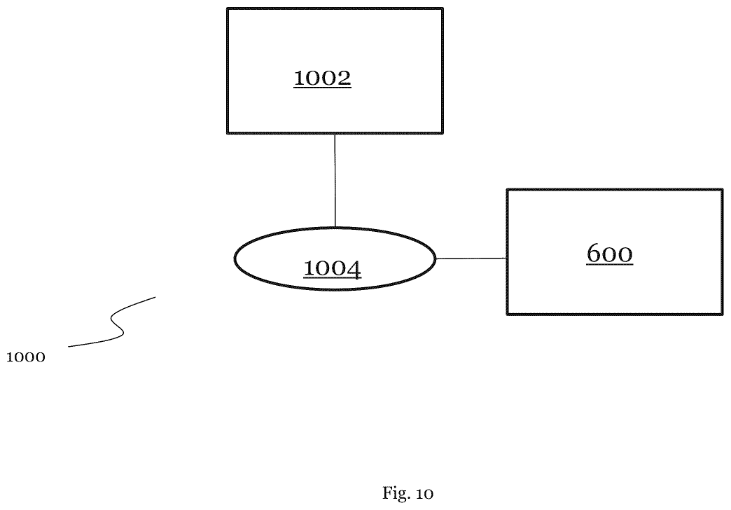

FIG. 10 depicts an early-fault detection system moo of an embodiment.

The early-fault detection system woo may comprise a motor 1002 or another device being monitored for a fault. The motor 1002 may be in communication with a sensor 1004 to detect the frequency of anomalous behavior that may represent an error of the motor 1002. The sensor 1004 may comprise an accelerometer in various embodiments. The sensor may comprise a digital microphone in various embodiments. The sensor may collect samples at a rate of 16 kSps. However, other sampling rates may be utilized in other embodiments.

The sensor 1004 may be in communication with a device 600 to analyze the frequencies detected by the sensor 1004. The device 600 may comprise a device with an improved power, speed, and resolution tradeoff of an embodiment. This may allow the analysis of the data to prioritize the speed of an FFT to more quickly diagnose potential errors in motor 1002.

For example, a 1024-point FFT, which may be desirable for high-frequency resolution, may require 64 milliseconds for the sensor 1004 to collect the samples to perform an FFT at a sampling rate of 16 kSps. Using a traditional device to perform an FFT, 46 milliseconds are needed after the last sample is collected to complete the FFT. A device 600 with an improved tradeoff between power, speed, and resolution allows an FFT to be completed merely 7.5 milliseconds after the last sample is collected.

This reduced latency may be advantageous to trigger corrective action, such as an emergency shutdown, more quickly. For example, a motor operating at 6000 rpm will complete a revolution every 10 milliseconds. With a traditional device, 4.6 revolutions must be completed after the last sample is collected before a fault can be detected and corrective action performed. Employing a device 600 with an improved tradeoff between power, speed, and resolution of a present embodiment, faults may be diagnosed after only ¾ of a revolution.

As will be appreciated by one skilled in the art, faults may be detected by comparing the frequency of the vibrations of a motor under normal operating conditions with abnormal conditions. For example, motor 1002 may be monitored during normal operating conditions to determine a normal frequency level for motor 1002. Observation may be accomplished using the sensor 1004 and the device 600 with an improved tradeoff between power, speed, and resolution which may comprise a microcontroller. A threshold level of variation from the normal frequency level may be set based on the observations during normal conditions, and variations beyond the threshold may trigger corrective action, like a shutdown. More specific correction action may be taken in various embodiments depending on what type of deviation is detected. For example, sampling a 6,000 rpm motor at 16 kHz may generate 80 coefficients for monitoring. As mentioned earlier, each revolution of a motor operating at 6,000 rpm takes 10 milliseconds. Vibrations can happen at h*100 Hz. With a sampling frequency of 1.6 kHz, the highest detected frequency is 8 kHz (half the sampling frequency). There are, thus, 80 coefficients for monitoring. Corrective action may be tailored based on which coefficient exhibits anomalous behavior.

In various embodiments a device 600 with an improved tradeoff between power, speed, and resolution may comprise a processor 602 with an FFT accelerator architecture.

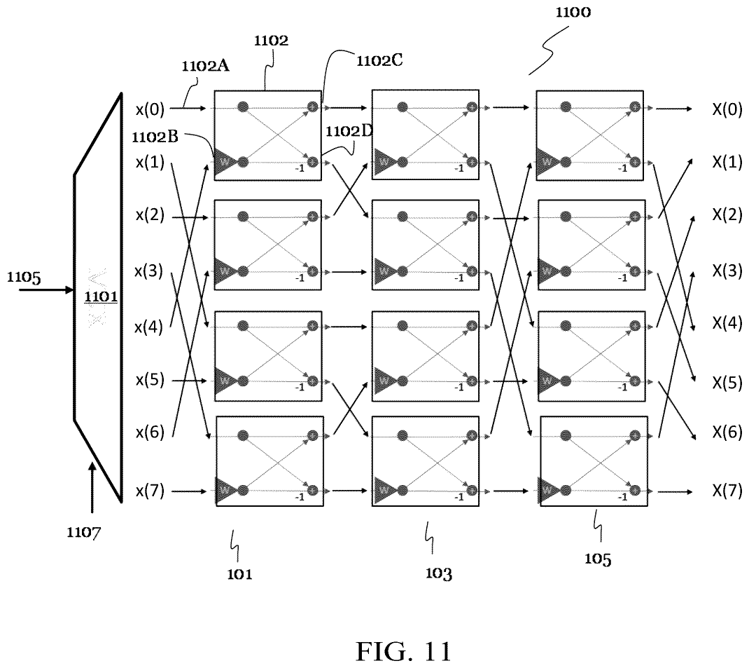

FIG. 11 illustrates an FFT accelerator 1100 of an embodiment.

The FFT accelerator 1100 may comprise a network of processing units, each processing unit corresponding to a butterfly operation of an FFT. Processing units may comprise an instruction control unit and an arithmetic unit. In various embodiments, processing units may be implemented by a dedicated hardware implementation (registers plus combinational logic or Application Specific Integrated Circuit) or a flexible hardware implementation (like a Field Programmable Gate Array), or by a microcode running on a microcontroller. The inputs to the processing units in the first stage of the FFT accelerator 1100 may correspond to the inputs for the corresponding butterfly operations of an FFT. For example, a first input 1102A for a first processing unit 1102 may comprise a first sample x(1) needed to perform the FFT. A second input 1102B for the first processing unit 1102 may comprise a 4th sample x(3). Each processing unit may also comprise two outputs. For example, the first processing unit 1102 may comprise a first output 1102C and a second output 1102D.

In FIG. 11, each processing unit is represented by a rectangle enclosing the corresponding butterfly operation, and data paths among processing units are represented by arrows. Outputs from the processing units may be directed towards other processing units as inputs for butterfly operations of the next stage in the sequence. Outputs from the processing units in the final stage may serve as outputs from the FFT accelerator. FIG. 11 depicts twelve processing units, which corresponds to an 8 sample FFT. However, in various embodiments, an FFT accelerator may comprise more or fewer processing units depending on the number of butterfly operations for an FFT, which, in turn, depends on the number of samples.

In various embodiments, the inputs for the processing units may comprise a data-valid bit, or flag, in addition to other bits to convey the input data. The processing unit may store data in a data register. The computation of the butterfly operation may be triggered when the data-valid bits for both inputs are asserted. This allows each butterfly operation to be performed as soon as data is received, which may offer an improved power, speed, and resolution tradeoff for a device.

The outputs of the processing units may also comprise a data-valid bit. This may indicate when a butterfly operation has been completed.

The data-valid flag on output is made available as an additional input for the data sources that provide the inputs, and it is used as a clear-to-send flag to indicate that new input can be accepted.

In various embodiments, data may be routed to the appropriate processing units of the first stage 101 with a multiplexer 1101. The multiplexer may receive data at an input 1105. Input 1105 may be coupled with interface 608. The input may receive the data samples for the FFT. Data may be received from a sensor collecting the samples. The multiplexer 1101 may comprise a selection input 1107 that determines where data received at input 1105 is output. The selection input 1107 may be coupled with a counter incremented with each sample. Various other embodiments may employ other means for routing data to processing units of the FFT accelerator 1100.

In various embodiments, an FFT accelerator 1100 may obviate the need for a data buffer in a device boo with an improved tradeoff between power, speed, and resolution. Data may be stored in data registers for the data processing units.

For an N-point FFT, no more than N/2 computations may be executed in parallel due to the input dependency of the butterfly operation on earlier computations. For this reason, a pipeline of log₂(N) stages may be reduced to 1 stage by re-using processing units.

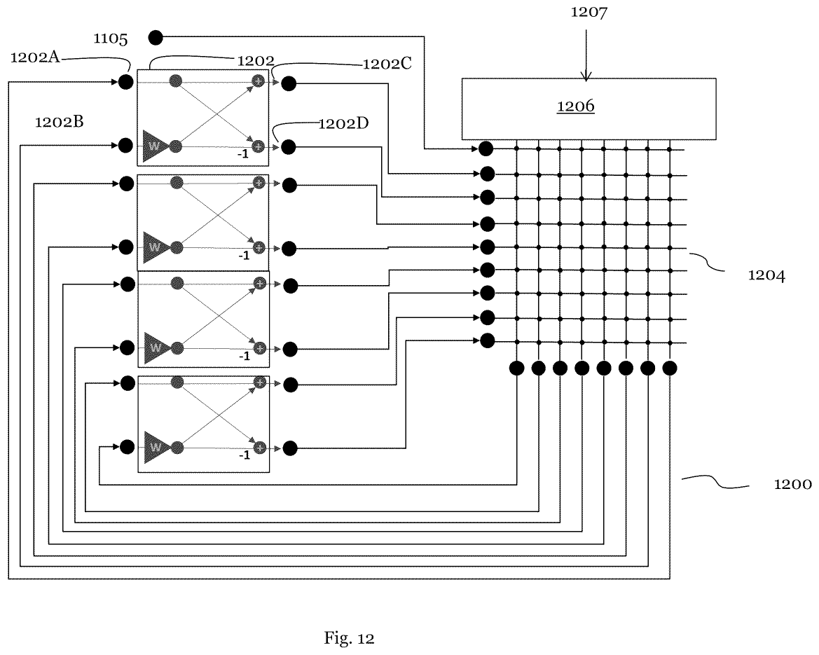

FIG. 12 illustrates a single-stage FFT accelerator 1200 of an embodiment.

A single-stage FFT accelerator 1200 may comprise N/2 data processing units. The number of processing units may be reduced from (N/2)*log₂(N), like may be used in an FFT accelerator with multiple stages like FFT accelerator 1100, to N/2 processing units by reusing the processing units. For an 8-point FFT, this may reduce the number of data processing units from 12 to 4, as is depicted in FIG. 12. Processing units may comprise an instruction control unit and arithmetic unit.

Each processing unit may comprise two inputs and two outputs. For example, processing unit 1202 may comprise a first input 1202A and a second input 1202B. The processing unit 1202 may comprise a first output 1202C and a second output 1202D. The inputs for the processing units may comprise a valid-data bit or flag. Performance of the butterfly operation may be triggered when the valid-data bit is asserted for each of the two inputs of a processing unit, which may allow the butterfly operation to be performed as soon as data becomes available. In various embodiments, outputs of the processing units may also comprise a valid-data bit to indicate when a butterfly operation is completed.

The single-stage FFT accelerator may further comprise an interconnection matrix 1204 coupled with the inputs and outputs of each of the data processing units. The interconnection matrix may route output data from any of the processing units to the inputs of any of the processing units. Routing may be determined by interconnection control logic 1206 based on a data index 1207 of the current data (data sample) and the data-valid flags of the outputs so that the input data is appropriately paired to perform the butterfly operations of an FFT. The complex coefficients for the butterfly operations may also be determined as a result of the data index 1207. As the data index is incremented or some data-flag (or combination of flags) are asserted, a single stage FFT accelerator 1200 may be triggered to transition to another state. Control logic 1206 may configure the interconnection matrix 1204 to transfer data to the appropriate location. The control logic 1206 may also retrieve and provide coefficients to data processing units, or provide information that allows data processing units to retrieve or compute the coefficients. And, the interconnect matrix 1204 may output final data (one word for each sample) when appropriate after computations for the final stage of an FFT are complete, which may be determined by the interconnection control logic 1206. Processing units may comprise a memory storing complex coefficients that may be retrieved depending on the butterfly operation being performed. Processing units may retrieve complex coefficients memory external to the processing unit.

Sequential processing of an FFT may be performed using a single data processing unit. In various embodiments, a device 600 with an improved tradeoff between power, speed, and resolution may comprise a single-unit FFT accelerator.

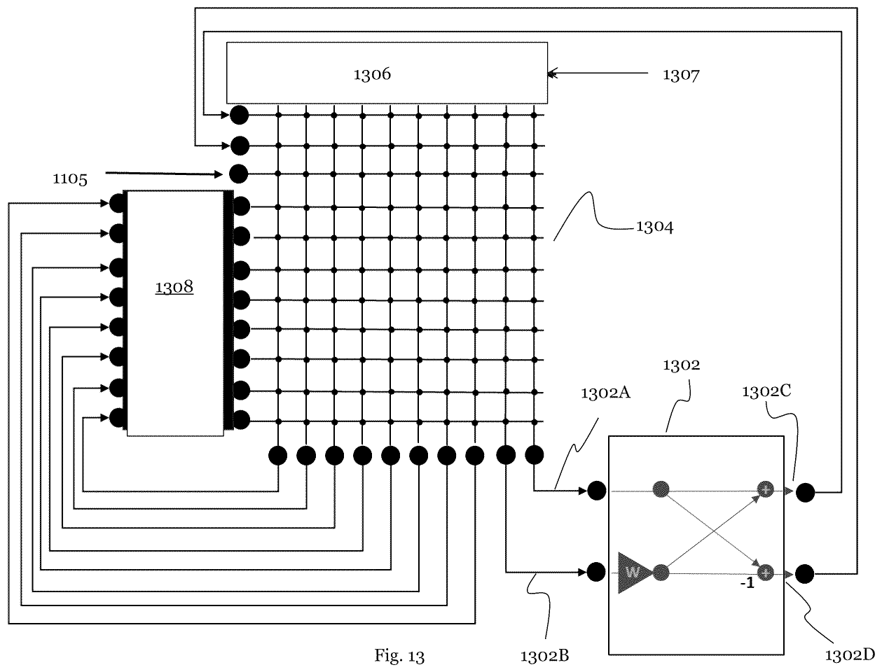

FIG. 13 depicts a single-unit FFT accelerator 1300 of an embodiment.

A single-unit FFT accelerator 1300 may comprise a data processing unit 1302. Data processing unit 1302 may comprise an instruction control unit and an arithmetic unit. All of the butterfly operations of an FFT may be performed by the lone data processing unit 1302. The data processing unit 1302 may comprise a first input 1302A and a second input 1302B. The data processing unit 1302 may comprise a first output 1302C and a second output 1302D. The first input 1302A and the second input 1302B may each comprise a data-valid bit, or flag, to allow data to be processed as soon as it is received. When the data-valid bit for both inputs is asserted, a butterfly operation may be triggered. The first output 1302C and the second output 1302D may also, each, comprise a data-valid bit, or flag to indicate when a butterfly operation is complete.

The first input 1302A, the second input 1302B, the first output 1302C, and the second output 1302D may all be coupled with an interconnect matrix 1304. The input 1105, for receiving sample data, may also be coupled with the interconnect matrix 1304. Data may thus bypass the data buffer 1308, when appropriate and be directed to the data processing unit 1302 by the interconnect matrix 1304. The interconnect matrix 1304 may direct data from the first output 1302C and the second output 1302D back to an input of the data processing unit 1302 or a data buffer 1308 that is also coupled with the interconnect matrix 1304. In various embodiments, the data buffer 1308 may comprise a location for each of the N samples of an FFT. For example, a data buffer may comprise 8 locations for an 8-point FFT (like depicted in FIG. 13). Data routing may be determined by interconnection control logic 1306 based on the data index 1307 of the current data (data sample) and the data-valid flags of the outputs. This may determine where data is routed (to a specified input of the data processing unit 1302 or a specific location of the data buffer 1308).

Data in the data buffer 1308 may be delivered to the interconnect matrix 1304 as soon a butterfly operation for that data is ripe for performance. In various embodiments, this may be determined by the data index 1307 of current data.

The complex coefficients for the butterfly operations may also be determined as a result of the data index 1307. As the data index is incremented or some data-flag (or combination of flags) are asserted, a single unit FFT accelerator 1300 may be triggered to transition to another state. Control logic 1306 may configure the interconnection matrix 1304 to transfer data to the appropriate location. The control logic 1306 may also retrieve and provide coefficients to data processing units, or provide information that allows data processing units to retrieve or compute the coefficients.

Example 1. A method to improve tradeoff between power, speed and resolution of a microcontroller performing a Fast Fourier Transform, the method including: receiving, by the microcontroller, N samples from a signal; and performing, by the microcontroller, a first butterfly operation of the Fast Fourier Transform before all of the N samples have been received from the signal, based on the performing of the first butterfly operation, the microcontroller performs the Fast Fourier Transform at an improved tradeoff between power, speed, and resolution.

Example 2. The method of Example 1, wherein the first butterfly operation is started before receiving N/2+2 samples of the N samples.

Example 3. The method of Examples 1 or Example 2, wherein the first butterfly operation is performed using a first chronological sample of the N samples and an N/2+1 sample chronological sample of the N samples.

Example 4. The method of Examples 1-3, further comprising performing, by the microcontroller, a second butterfly operation before receiving N/2+3 samples of the N samples.

Example 5. The method of Examples 1-4, wherein the second butterfly operation is performed using a second chronological sample of the N samples and an N/2+2 chronological sample of the N samples.

Example 6. The method of Examples 1-4, further comprises performing, by the microcontroller, N/2*log₂(N) butterfly operations.

Example 7. The method of Examples 1-6, further comprising performing, by the microcontroller, N−1 butterfly operations after receiving all N samples from the signal.

Example 8. The method of Example 1-7, wherein each butterfly operation receives two input values and produces two output values.

Example 9. The method of Examples 1-8,further comprising: performing each butterfly operation of the Fast Fourier Transform using a multi-core processor of the microcontroller; and finishing the Fast Fourier Transform after N−1 butterfly operations are performed after all N samples are received by the microcontroller.

Example 10. The method of Examples 1-9, further comprising performing each butterfly operation of the Fast Fourier Transform using a single-core processor of the microcontroller; and improving the performance of the single-core processor by reducing a number of butterfly operations performed after receiving the N samples.

Example 11. The method of Examples 1-10, further comprising performing each butterfly operation of the Fast Fourier Transform using a FFT accelerator of the microcontroller.

Example 12. The method of Examples 1-11 further comprising triggering performance of the first butterfly operation when a data-valid bit of a first input of the first butterfly operation is asserted and when a data-valid bit of a second input of the first butterfly operation is asserted.

Example 13. A method to improve tradeoff between power, speed, and resolution of a microcontroller performing a Fast Fourier Transform, the method including: receiving, by the microcontroller, N samples from a signal; performing, by the microcontroller, N/2*log₂(N) butterfly operations of the Fast Fourier Transform using the N samples; and initializing a performance of a first butterfly operation when a first data set becomes available, based on the performance of the first butterfly operation.

Example 14. The method of Example 13, wherein the first data set comprises a first chronological sample of the N samples and an N/2+1 chronological sample of the N samples.

Example 15. The method of Example 13 or Example 14, further comprising initializing a second butterfly operation when a second data set becomes available.

Example 16. The method of Example 13-15, wherein the second data set comprises a second chronological sample of the N samples and an N/2+2 chronological sample of the N samples.

Example 17. The method of Example 13-16, further comprising initializing each of the N/2*log₂(N) butterfly operations when a corresponding data set becomes available.

Example 18. An electronic device to perform a Fast Fourier Transform, the electronic device including: an interface configured to receive N samples collected from a signal; a processor coupled to the interface; and a non-transitory memory storing a program to be executed in the processor, the program comprising instructions when executed, causes the processor to: perform a first butterfly operation of the Fast Fourier Transform before all of the N samples have been collected from the signal.

Example 19. The electronic device of Example 18, wherein, the instructions, when executed, cause the first butterfly operation to start before N/2+2 samples of the N samples have been collected.

Example 20. The electronic device of Example 18 or Example 19, wherein the first butterfly operation is performed using a first chronological sample of the N samples and an N/2+1 sample chronological sample of the N samples.

Example 21. The electronic device of Example 18-20, wherein, the instructions, when executed, cause the processor to perform a second butterfly operation before N/2+3 samples of the N samples have been collected.

Example 22. The electronic device of Example 18-21, further comprising a data buffer comprising N locations and wherein the processor is configured to store a result of the Fast Fourier Transform in each of the N locations.

Example 23. The electronic device of Example 18-22, wherein the processor comprises a multi-core processor.

Example 24. The electronic device of Example 18-23, further comprising a battery configured to power the processor.

Example 25. The electronic device of Example 18-24, wherein the processor comprises an FFT accelerator comprising a first input and a second input, each of the first input and the second input comprising a data-valid bit that, when asserted, triggers performance of the first butterfly operation.

Example 26. The electronic device of Example 18-25, further comprising an intermediate data buffer to provide temporary storage for the N samples, the intermediate data buffer comprising a First In First Out buffer and being coupled with the interface and the processor.

The references used herein are provided merely for convenience and hence do not define the extent of protection or the scope of the embodiments.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An electronic device, comprising:
N/2 number of processors for performing a Fast Fourier Transform (FFT) on a data set having N samples, each processor configured to generate two output samples based on an FFT butterfly operation on a unique pair of two input samples of the N samples in accordance with a multi-stage FFT operation;
an interconnect matrix coupled to the processors, the interconnect matrix configured to route output samples from each processor as input samples to one of the N/2 number of processors at a subsequent stage of the multi-stage FFT operation or as final output at a final stage of the multi-stage FFT operation; and
a control logic coupled to the interconnect matrix, wherein the interconnect matrix is configured to route the two output samples based on a determination by the control logic in accordance with a data index, the data index indicating samples being operated on at any given moment by the N/2 number of processors.

2. The electronic device of claim 1, wherein each processor comprises an input valid-data bit, and wherein each processor is configured to begin the FFT butterfly operation on the unique pair of two input samples in response to the input valid-data bit being asserted.

3. The electronic device of claim 1, wherein each processor comprises an output valid-data bit indicating a completion status of the FFT butterfly operation on the unique pair of two input samples.

4. The electronic device of claim 3, wherein the interconnect matrix is configured to route output samples based on a determination by the control logic in accordance with the output valid-data bit for the processors and the data index.

5. The electronic device of claim 1, wherein the control logic is configured to provide complex coefficients to each processor for each FFT butterfly operation in accordance with the data index.

6. The electronic device of claim 1, wherein each processor is configured to compute complex coefficients for the FFT butterfly operation.

7. The electronic device of claim 1, wherein each processor comprises a memory configured to store complex coefficients for FFT butterfly operations, and wherein each processor is configured to retrieve a complex coefficient for a current FFT butterfly operation from the memory.

8. The electronic device of claim 1, wherein the number of stages in the multi-stage FFT operation equals Log e (N).

9. The electronic device of claim 1, wherein each processor is implemented as registers with combinational logic, an application-specific integrated circuit (ASIC), a field programmable gate array (FPGA), or a microcode running on a microcontroller.

10. A method, comprising:
generating, by each processor of N/2 number of processors, two output samples based on a Fast Fourier Transform (FFT) butterfly operation on a unique pair of two input samples of a data set having N samples, the generating being in accordance with a multi-stage FFT operation;
routing, by an interconnect matrix coupled to each processor, output samples from each processor as input samples to one of the N/2 number of processors at a subsequent stage of the multi-stage FFT operation or as final output at a final stage of the multi-stage FFT operation; and
controlling, by a control logic coupled to the interconnect matrix, the routing based on a determination by the control logic in accordance with a data index, the data index indicating samples being operated on at any given moment by the N/2 number of processors.

11. The method of claim 10, wherein each processor comprises an input valid-data bit, the method further comprising beginning the FFT butterfly operating on the unique pair of two input samples in response to an input valid data being asserted.

12. The method of claim 10, wherein each processor comprises an output valid-data bit indicating a completion status of the FFT butterfly operation on the unique pair of two input samples.

13. The method of claim 12, wherein the controlling comprises controlling the routing based on the output valid-data bit and the data index.

14. The method of claim 10, further comprising providing, by the control logic to each processor, complex coefficients for each FFT butterfly operation in accordance with the data index.

15. The method of claim 10, further comprising computing, by each processor, complex coefficients for the FFT butterfly operation.

16. The method of claim 10, wherein each processor comprises a memory for storing complex coefficients for FFT butterfly operations, the method further comprising retrieving, by each processor, a complex coefficient for a current FFT butterfly operation from the memory.

17. The method of claim 10, wherein the number of stages in the multi-stage FFT operation equals Log₂(N).

18. The method of claim 10, wherein each processor is implemented as registers with combinational logic, an application-specific integrated circuit (ASIC), a field programmable gate array (FPGA), or a microcode running on a microcontroller.

19. An electronic device, comprising:
a processor for performing a Fast Fourier Transform (FFT) on a data set having N samples, the processor configured to generate two output samples based on an FFT butterfly operation on a unique pair of two input samples of the N samples in accordance with a multi-stage FFT operation;
an interconnect matrix coupled to the processor, the interconnect matrix configured to route output samples from the processor as input samples to the processor for a subsequent FFT butterfly operation or as final output at a final stage of the multi-stage FFT operation;
a data buffer coupled to the interconnect matrix, the data buffer configured to store samples at various stages of the multi-stage FFT operation and provide samples to be routed by the interconnect matrix to the processor in response to the processor being ready for performing the FFT butterfly operation; and
a control logic coupled to the interconnect matrix, wherein the interconnect matrix is configured to route the two output samples based on a determination by the control logic in accordance with a data index, the data index indicating samples being operated on at any given moment by the N/2 number of processors.

20. The electronic device of claim 19, wherein the processor is implemented as registers with combinational logic, an application-specific integrated circuit (ASIC), a field programmable gate array (FPGA), or a microcode running on a microcontroller.

21. The electronic device of claim 19, wherein the processor comprises an input valid-data bit, and wherein the processor is configured to begin the FFT butterfly operation on the unique pair of two input samples in response to the input valid-data bit being asserted.

22. The electronic device of claim 19, wherein the processor comprises an output valid-data bit, and wherein the interconnect matrix is configured to route output samples based on a determination by the control logic in accordance with the output valid-data bit and the data index.

23. The electronic device of claim 19, wherein the control logic is configured to provide complex coefficients to the processor for each FFT butterfly operation in accordance with the data index.

24. The electronic device of claim 19, wherein the processor is configured to compute complex coefficients for the FFT butterfly operation.

25. The electronic device of claim 19, wherein the processor is configured to directly receive input samples from the interconnect matrix and bypassing the data buffer.

26. The electronic device of claim 19, wherein the number of stages in the multi-stage FFT operation equals Log₂(N).
